(19) United States
(12) Patent Application Publication
(10) Pub. No.: US 2022/0008281 A1
(43) Pub. Date: Jan. 13, 2022

(54) DEVICE FOR CONNECTING A LEG OF A PERSON TO A MOVEMENT MECHANISM

(71) Applicant: REACTIVE ROBOTICS GMBH, München (DE)

(72) Inventors: Alexander Koenig, Muenchen (DE); Maximilian Grosse-Dunker, Puchheim (DE); Joachim Jahn, Muenchen (DE); Ramona Susanna Schlaefer, Muenchen (DE); Helmut Oschwald, Muenchen (DE); Olaf Schikorr, Hamburg (DE); Manfred Koestlmeier, Haar (DE)

(21) Appl. No.: 17/296,288

(22) PCT Filed: Nov. 25, 2019
(86) PCT No.: PCT/DE2019/101006

§ 371 Date: May 24, 2021

(30) Foreign Application Priority Data
Nov. 23, 2018 (DE) 10 2018 129 647.9

(51) Int. Cl. A61H 1/02

(52) U.S. Cl. CPC A61H 1/0237; A61H 2201/1671; A61H 2201/165; A61H 2201/1642

(57) ABSTRACT

A device for connecting a leg of a person to a movement mechanism includes a retaining element. The retaining element has at least one connecting element for directly connecting the retaining element to the movement mechanism, and a fixing device for fixing the leg of the person to the retaining element. The connecting element can rotate relative to a longitudinal axis thereof. The device advantageously permits simple and quick connection of the user to the device and also of the device, together with the user, to a movement mechanism. The device is easy to operate by third parties and also by the user, is easy to clean and disinfect and affords the user a high level of wearing comfort. The device also ensures controlled transmission of movement from the movement mechanism, in particular to the legs of the user, and in addition can be produced cost-effectively.

The present invention relates to a device for connecting a leg of a person to a movement mechanism.

For the automated movement of human extremities, particularly in the context of mobilization therapy or rehabilitation measures or during sports-oriented training, a number of robot-assisted movement mechanisms have been developed in recent years, which make it possible, for example, to automatically move a person's legs and/or feet in a controlled manner. For example, DE 10 2015 117 596 B3 has disclosed a rehabilitation mechanism for bedridden patients, a method for control of said rehabilitation mechanism, and also a bed comprising the rehabilitation mechanism. WO 00/61059 A1 has disclosed a device and a method for locomotion therapy in which a patient is held on a standing table, and an automated leg movement is executed by means of a drive mechanism consisting of a knee part and a foot part for each leg. The knee part of the drive mechanism lies here below the respective leg, in particular below the respective knee joint, of the patient and raises or lowers the leg through extension of the knee part or retraction of the knee part perpendicular to the plane of the standing table. Finally, WO 97/00661 A1 has disclosed an exercise apparatus and an exercise method permitting controlled exercises and support of, among other things, the legs of a patient. For this purpose, a knee orthosis in particular is disclosed whose degrees of freedom of movement can be controlled in a therapy-dependent manner.

A decisive factor for the success of such automated movement training is among other things the physical connection of the automated movement mechanism to the respective person, where, in addition to the comfort of the person training or the patient, simple handling for trainers, physiotherapists and/or nursing staff, as well as the possibility of controlled transmission of the movement predetermined by the movement mechanism to the person, in particular to the outer extremities such as the legs or arms, plays a significant role. Particularly in the case of bedridden intensive care patients, the compatibility of such a mobilization measure with the other medically required therapy facilities, such as catheters or measuring lines for diagnostic devices, is also of importance. Due to their often complex set-up, the leg orthoses known for corresponding purposes from the prior art do not allow the user to be connected quickly to a corresponding movement mechanism in a way that takes into account the medical conditions of the respective patient.

Proceeding from this, the object of the present invention is to make available a device for connecting a leg of a person to a movement mechanism, which device is improved, in particular simplified, in relation to the prior art, is easy to handle under hygienic conditions by the user himself and by third parties, affords a high level of comfort and, while ensuring controlled transmission of movement from the movement mechanism, in particular to the legs of a person, can in addition be produced cost-effectively.

This object is achieved by a device for connecting a leg of a person to a movement mechanism, having the features of independent claim 1. Further advantageous embodiments and developments that can be used individually or in combination with one another are the subject matter of the dependent claims.

A device according to the invention comprises at least one retaining element, wherein the retaining element has at least one connecting element for directly connecting the retaining element to the movement mechanism, and a fixing means for fixing the leg of the person to the retaining element, and is characterized in that the connecting element is designed in such a way that a rotation of the retaining element with respect to a longitudinal axis of the connecting element is permitted.

The device according to the invention advantageously permits simple and quick connection of the user to the device and also of the device, together with the user, to a movement mechanism. The device is easy to operate by third parties and by the user himself, is easy to clean and disinfect and affords the user a high level of wearing comfort. The device according to the invention also ensures controlled transmission of movement from the movement mechanism, in particular to the legs of the user, and in addition can be produced cost-effectively. The rotatability advantageously creates additional degrees of freedom in the connection between user and movement mechanism, as a result of which undesired external forces on the leg or knee of the user can be reduced, which advantageously leads to enhanced wearing comfort and to a reduced risk of injury. Moreover, the device can thus be still better adapted to the shape of the leg, in particular the thigh, of the user, and the pressure applied and/or the force introduced via the device can also be distributed particularly uniformly over the whole surface of the thigh. This again advantageously enhances the wearing comfort and lessens the chance of pressure points occurring on the skin of the user.

In a preferred embodiment of the invention, the retaining element can be designed at least partially in an arc shape with an arc that opens counter to the extension of the connecting element, wherein the opening radii (Rₚ; R_{d}) of a proximal longitudinal side and of a distal longitudinal side of the retaining element can be equal or different. A retaining element designed at least partially in an arc shape can advantageously be adapted to the anatomical shape of a leg, in particular the thigh, of the person. It is particularly preferable if the opening radius (Rₚ) of the proximal longitudinal side and the opening radius (R_{d}) of the distal longitudinal side of the first retaining element are different, i.e. are defined by two different radii, particularly in such a way that the retaining element has a conical shape, preferably tapering in the distal direction, and thus adapts well to the usual anatomical shape of a thigh.

In a further embodiment of the invention, the retaining element can preferably be made of a relatively stiff material, in particular of plastic.

A retaining element thus made of a relatively stiff material advantageously permits stable retention of the patient's leg and also a controlled transmission of force, distributed over a relatively large surface area, from the rehabilitation mechanism to the leg, in particular the thigh, of the patient via the device. The distribution of the supplied force over a larger surface area advantageously enhances the training comfort for the user. The use of plastic, in particular a plastic or a plastic mixture suitable for industrial production, such as plastic injection molding or 3D printing technology, advantageously permits relatively inexpensive production even in different sizes (different lengths, widths, arc radii, etc.), preferably by a 3D printing method. Moreover, a retaining means made of plastic advantageously has a comparatively low weight, sufficient strength and robustness and thus longevity, and is also advantageously easy to clean or disinfect.

It is additionally preferred if the retaining means is at least partially surface-treated, in particular surface-coated. Surface treatment, in particular surface coating, advantageously increases simple and quick cleaning or disinfection of the retaining means, such that the latter can advantageously remain connected to the movement mechanism between successive uses with different users, even in a sector with the highest hygiene requirements. It is particularly advantageous if the surface coating comprises germ-reducing substances, in particular silver and/or copper ions, and thereby itself has a germ-reducing effect.

In a further preferred embodiment of the invention, the connecting element, with respect to an upper side, in particular with respect to a proximal longitudinal side and a distal longitudinal side and/or with respect to the transverse sides of the retaining element, can be arranged centrally on the upper side of the retaining element. A central arrangement of the connecting means advantageously permits a uniform introduction of force from the movement mechanism to the leg of the user.

It has additionally proven expedient that the retaining element has, on its upper side, holders for the fixing means. It is particularly advantageous here if at least two holders are provided which are connected directly or indirectly, in particular via fastening means, to the retaining element, wherein the holders are designed to be pivotable with respect to the longitudinal axis and/or the normal to the upper side of the retaining element; and/or wherein the holders are designed to be rotatable with respect to the transverse axis and/or the normal to the upper side of the retaining element. A fixing means connected to the retaining element by means of such holders advantageously takes into account the anatomy of the respective user (different thigh angles/diameters, etc.), wherein the device is particularly suitable for adapting to a conically shaped leg or a conically shaped thigh by forming a conical shape of its own, and for adapting to a cylindrically shaped leg or a cylindrically shaped thigh by forming a cylindrical shape of its own.

In a further embodiment, it has proven expedient that the fixing means is formed from a flexible material and/or has at least one closure. A flexible fixing means advantageously permits simple and comfortable connection of the user to the retaining element or to the device and thus to the movement mechanism. In particular, the provision of a closure advantageously allows a user, who is connected to medical catheters, to be easily connected to the device and thus to the movement mechanism. Moreover, a fixing means designed in this way advantageously permits an adaptation of the flexible material to the thigh of the user, which in turn advantageously enhances the convenience of use by allowing forces to be transmitted over a large surface area to the leg or thigh of the user. In addition, a fixing means of this kind can advantageously enhance the wearing comfort and can also ensure a hygienic separation of retaining element and user, wherein the fixing means can remain on the user until completion of the training or therapy and can advantageously be cleaned or disinfected individually.

In addition, an embodiment is preferred in which the fixing means can be reversibly connectable to the retaining element via at least one of its transverse sides. A reversible connection can preferably be realized by the provision of at least one hook-and-loop closure and/or of press studs and/or by at least one magnetic closure or the like and advantageously permits simple buckling or unbuckling of the device, in particular taking account of any medical circumstances when used by intensive care patients, for example taking account of medical catheter connections. In addition, a reversible connection advantageously allows a fixing means to be replaced, in particular by another fixing means of different length and/or of a different type, and thus advantageously improves the adaptability to the respective user.

An embodiment of the invention has also proven expedient in which a first padding element corresponding in design preferably to the retaining element, in particular to an underside of the latter, can be arranged on the underside of the retaining element and can be reversibly connectable to the retaining element directly or indirectly via at least one connecting means. A first padding element can advantageously enhance the wearing comfort and also ensure a hygienic separation of retaining element and user, wherein the first padding element remains on the user until completion of the training or therapy and can advantageously be cleaned or disinfected individually. Alternatively, the first padding element can also be formed from a comparatively rigid core, in particular from plastic, and a comparatively soft covering, in particular from silicone or the like.

It is likewise advantageous if the first padding element, in particular its connecting means, comprises at least one closure, in particular in the form of a press stud and/or a magnetic closure. As a result, the first padding element can advantageously be fastened to and released again from the holding element quickly and easily. In the case of a magnetic closure, a plastic-encased flat magnet can preferably be used, which offers hygienic advantages by virtue of the seamless construction that this permits.

In a further preferred embodiment, a second, in particular at least partially arc-shaped padding element can be arranged on the fixing means. A second padding element can additionally stabilize the user and can advantageously enhance the wearing comfort for the user by preventing the fixing means from cutting into the thigh or rubbing against the thigh or by reducing the pressure load on the underside of the thigh.

It is also advantageous if the second padding element is displaceable with respect to a longitudinal side of the fixing means and/or reversibly connectable to the fixing means, in particular via a holder embodied by a guide slot and/or tunnel or designed as a hook-and-loop fastener. This can advantageously improve the adjustability or adaptability of the device to the anatomy of the respective user and allows the device to be produced with the smallest possible variability of size, while at the same time covering a large range of anatomical size relationships.

Finally, an embodiment of the invention has proven expedient in which the first padding element or second padding element is made entirely or partially of an elastic material; wherein the second padding element can additionally comprise a support element made of a rigid material, in particular of plastic, preferably of the same plastic as the retaining element. The use of an elastic material advantageously offers additional padding for the leg or thigh of the user and thus additionally enhances the wearing comfort. The use of a rigid material advantageously permits better fixing (dimensional stability) of the second padding means compared to the simple arrangement thereof on the (flexible) fixing means. Alternatively, the second padding element can also be formed from a comparatively rigid core, in particular from plastic, and a comparatively soft covering, in particular from silicone or the like.

Additional details and further advantages of the invention are described below on the basis of preferred illustrative embodiments, to which the invention is not limited however, and in conjunction with the attached schematic drawings, in which:

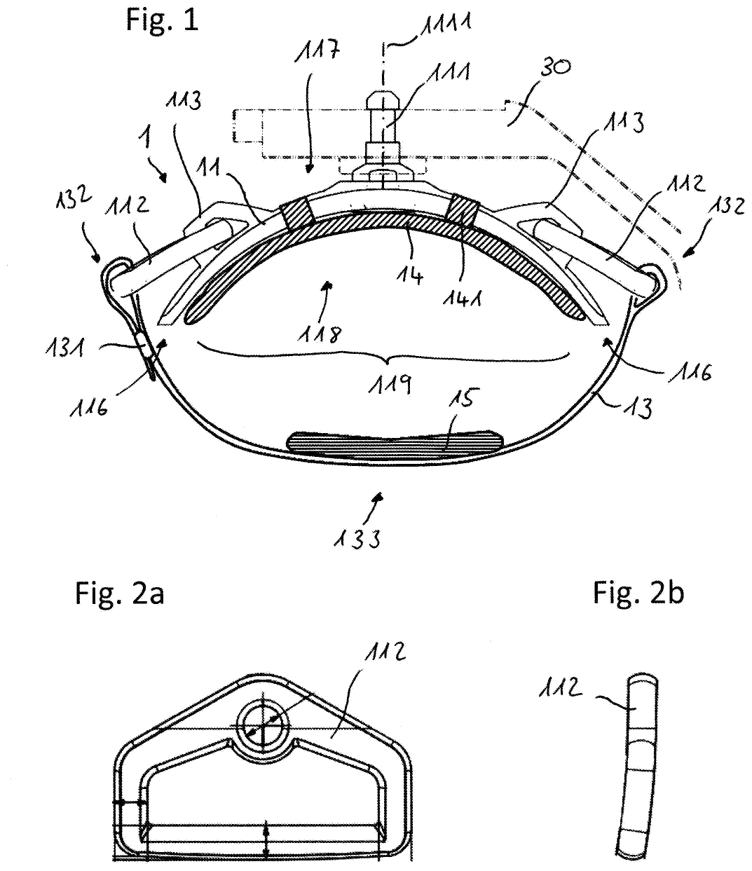

FIG. 1 shows a side view of an embodiment of a device according to the invention;

FIG. 2a shows a front view of an embodiment of a holder for a fixing means;

FIG. 2b shows a side view of the holder from FIG. 2a;

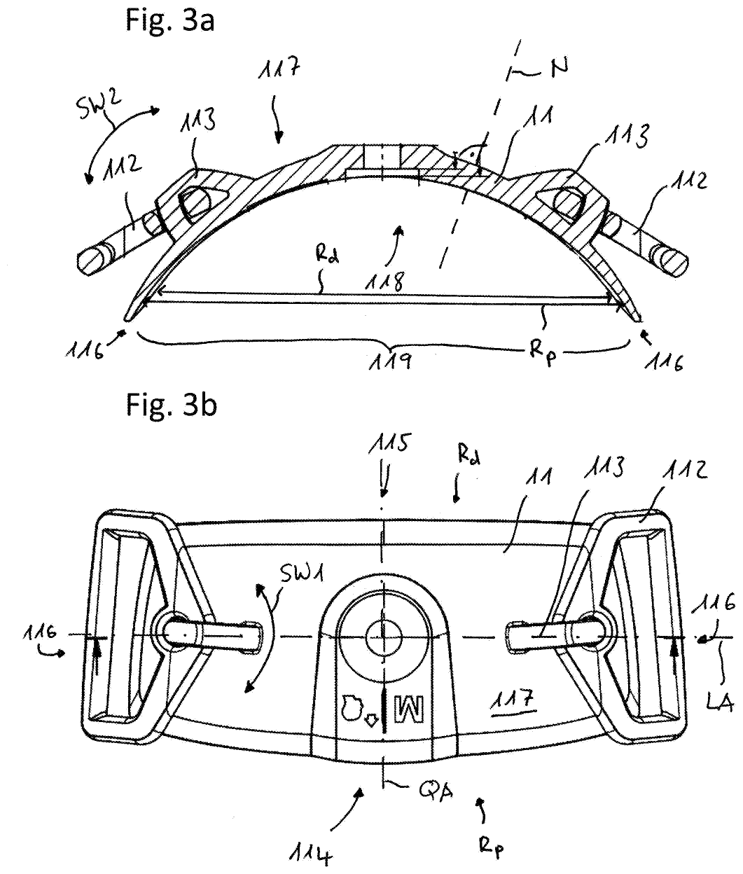

FIG. 3a shows a section along a longitudinal axis of an embodiment of a retaining element;

FIG. 3b shows a plan view of the retaining element from FIG. 3a;

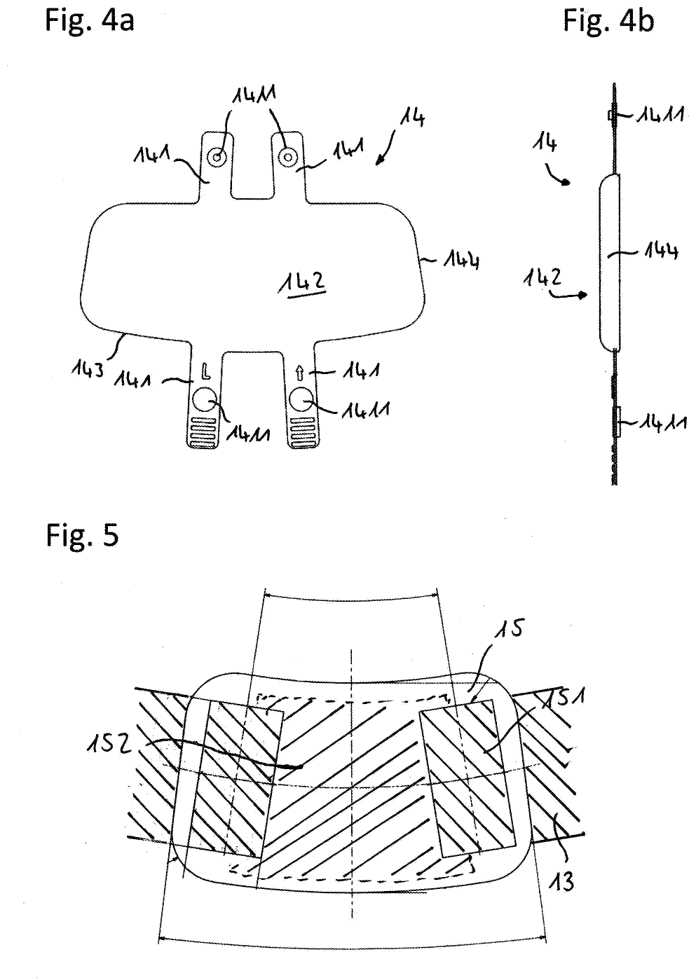

FIG. 4a shows a plan view of an embodiment of a first padding element;

FIG. 4b shows a side view of the first padding element from FIG. 4a; and

FIG. 5 shows a plan view of an embodiment of a second padding element.

In the following description of preferred embodiments of the present invention, identical reference signs designate the same or comparable components.

FIG. 1 shows a side view of an embodiment of the device 1 according to the invention. A device 1 according to the invention for connecting a leg of a person to a movement mechanism 30 comprises at least one retaining element 11, wherein the retaining element 11 has at least one connecting element 111 for directly connecting the first retaining element 11 to the movement mechanism 30, and a fixing means 13 for fixing the leg of the person to the retaining element 11.

The connecting element 111, preferably with respect to an upper side 117, in particular with respect to a proximal longitudinal side 114 and a distal longitudinal side 115 and/or with respect to the transverse sides 116 of the retaining element 11, can be arranged centrally on the upper side 117 of the retaining element 11. According to the invention, the connecting element 111 is designed in such a way that a rotation of the retaining element 11 with respect to a longitudinal axis 1111 of the connecting element 111 is permitted. In the embodiment of the invention shown in FIG. 1, the connecting element 111 is designed for example as a pin which can be guided through an opening in the retaining element 11 and can be mounted rotatably on the retaining element 11 or arranged fixedly thereon. The connecting element can be produced from a plastic, in particular from the same plastic as the retaining element 11, but is preferably made of metal, since a connecting means 111 made of metal, in particular a metal pin, is able to withstand greater forces. For quick connection of the device 1 to the movement mechanism 30 or for quick removal thereof from the movement mechanism 30, the connecting means 111 can in addition be preferably designed to correspond to a quick-action fastener on the movement mechanism 30.

The retaining element 11 can be designed at least partially in an arc shape with an arc 119 that opens counter to the extension of the connecting element 11. The arc 19 is defined by two opening radii Rₚ; R_{d}, wherein the opening radius Rp of a proximal longitudinal side 114 and the opening radius Rd of a distal longitudinal side 115 of the retaining element 11 can be equal or different. The retaining element 11 can be made of a relatively stiff material, in particular of plastic, which advantageously has enough stability to permit stable retention of the leg of a user and to permit a force distribution that is as uniform as possible, while at the same time still being flexible enough to ensure that the retaining means 11 is able to bend to a certain extent and can thus additionally adapt to the leg, in particular the thigh, of the user. In addition, the retaining means 11 can preferably be at least partially surface-treated, in particular surface-coated.

It will also be seen from FIG. 1 that the retaining element 11 can preferably have, on its upper side 117, holders 112 for the fixing means 13.

FIGS. 2a and 2b show an embodiment of such a holder 112 for a fixing means 13 in a front view (FIG. 2a) and in a side view (FIG. 2b). The holders 112 can preferably be formed from the same material as the retaining element 11 and, in a 3D printing method for the manufacture of a device 1 according to the invention, can therefore advantageously be produced together with the retaining element 11, and already connected to the latter. As can be seen from FIG. 2b, the holder 12 can advantageously be slightly curved so as to protrude slightly from the surface 117 of the retaining element 11 when arranged thereon. For this purpose, the slightly curved holder 112 can preferably be connected to the retaining element 11 such that the convex face of the holder 112 is directed away from the surface of the retaining element 11.

FIG. 3a shows a section along a longitudinal axis LA of an embodiment of a retaining element 11, and FIG. 3b shows a plan view of the retaining element 11 from FIG. 3a.

As is shown, it is advantageous if at least two holders 112 are provided which are connected directly or indirectly, in particular via fastening means 113, to the retaining element 11. The holders 112 can be designed to be pivotable with respect to the longitudinal axis LA and/or the normal N to the upper side 117 of the retaining element 11. Alternatively or in addition, the holders 112 can be designed to be rotatable with respect to the transverse axis QA and/or the normal N to the upper side 117 of the retaining element 11. In FIGS. 3a and 3b, this flexibility of the two holders 112 shown here is indicated by the pivoting angles SW1 (FIG. 3b) and SW1 (FIG. 3a). Any desired combination of the pivoting and/or rotating movements symbolized by the two pivoting angles SW1 and SW2 advantageously generates, for each of the holders 112, degrees of freedom of movement in all three spatial directions. In the embodiment of the invention shown here, this mobility is realized technically by arranging eyelet-shaped fastening means 113, which are preferably made of the same material as the retaining element 11, on the surface 117 of the retaining element 11, which can advantageously likewise already be done during the 3D printing of the retaining element. The holders 112 can then preferably each have at least one opening which is designed corresponding to these eyelet-shaped fastening means 113 and via which the holders 112 can be connected to the retaining element 11.

Generally speaking, pivotably and/or rotatably mounted holders designed in this way advantageously permit an adaptation to the anatomical shape of the leg, in particular the thigh, of the user and for example advantageously permit the formation of a conical shape made up of retaining element 11 and fixing means 13. The combination of a comparatively wider opening radius Rₚ of the proximal longitudinal side 114 of the retaining element and a comparatively narrower opening radius R_{d} of a distal longitudinal side 115 of the retaining element 11, as is shown in particular in FIG. 3b as transverse sides 116 tapering toward the distal longitudinal side 115 (clearly seen by comparison with the holders 112), can advantageously support the formation of a cone shape adapted to the leg or thigh and can thus also enhance the wearing comfort.

The fixing means 13 can preferably be formed from a flexible material, for example from a flexible hook-and-loop tape, as a result of which the connection between user and retaining element 11 is made easier. Alternatively or in addition to this, the fixing means 113, as shown in FIG. 1, can have at least one closure 131, preferably a hook-and-loop closure or a magnetic closure, which can further simplify the connection, particularly if the user is a bedridden patient, in particular a coma patient, who is to be mobilized with the aid of the movement mechanism 30. Such patients are often provided with medicine via catheters, and the latter have to be taken into account when connecting the patient to a movement mechanism 30. As is shown in FIG. 1, the fixing means 13 can preferably be reversibly connectable to the retaining element 11 via at least one of its transverse sides 132. However, it is thus also possible that the fixing means 113 is reversibly connectable to the retaining element 11 via its two transverse sides 132, preferably via holders 112, and in particular can have two closures 131.

In addition, a first padding element 14 corresponding in design preferably to the retaining element 11, in particular to an underside 118 of the latter, can be arranged on the underside 118 of the retaining element 11 and can be reversibly connectable to the retaining element 11 directly or indirectly via at least one connecting means 141.

FIGS. 4a and 4b show an embodiment of a first padding element 14 in a plan view (FIG. 4a) and in a side view (FIG. 4b). As is shown, the first padding element 114, in particular its connecting means 141, advantageously comprises at least one closure 1411, in particular in the form of a press stud and/or a magnetic closure.

FIG. 1 also shows that a second, in particular at least partially arc-shaped padding element 15 can be arranged on the fixing means 13 and, during use of the device 1, is likewise arranged substantially axially symmetrically with respect to the longitudinal axis 1111 of the connecting element 111, just like the first padding element 14.

FIG. 5, finally, shows a plan view of an embodiment of such a second padding element 15. It is of advantage here if the second padding element 15 is displaceable with respect to a longitudinal side 133 of the fixing means 13 and/or reversibly connectable to the fixing means 13, in particular via a holder 151 embodied by a guide slot and/or tunnel or designed as a hook-and-loop fastener. In addition, the first padding element 114 or the second padding element 15 can advantageously be made entirely or partially of an elastic material; wherein the second padding element 15 can additionally comprise a support element 152 made of a rigid material, in particular of plastic, preferably of the same plastic as the retaining element 11. As can be seen in particular from FIG. 4b, the first padding element 14 and the second padding element 15 can finally have rounded edges, for further enhancing the wearing comfort.

The device 1 according to the invention advantageously permits simple and quick connection of the user to the device 1 and also of the device 1, together with the user, to a movement mechanism 30. The device is easy to operate by third parties and by the user himself, is easy to clean and disinfect and affords the user a high level of wearing comfort. The device 1 according to the invention also ensures controlled transmission of movement from the movement mechanism 30, in particular to the legs of the user, and in addition can be produced cost-effectively.

### LIST OF REFERENCE SIGNS

1 device
11 retaining element
   111 connecting element
      1111 longitudinal axis of the connecting element 111
   112 holder for the fixing means 13
   113 fastening means for the holder 112
   114 proximal longitudinal side of the retaining element 11
   115 distal longitudinal side of the retaining element 11
   116 transverse side of the retaining element 11
   117 upper side of the retaining element 11
   118 underside of the retaining element 11
   119 arc
13 fixing means
   131 closure
   132 transverse side of the fixing means 13
   133 longitudinal side of the fixing means 13
14 first padding element
   141 connecting means
      1411 closure
   142 surface
   143 longitudinal side of the padding element 14
   144 transverse side of the padding element 14
15 second padding element
   151 holder for the fixing means 13
   152 support element for the second padding element 15
30 movement mechanism
LA longitudinal axis of the device 1
QA transverse axis of the device 1
N normal to the upper side 116 of the retaining element 11
Rₚ opening radius of the proximal longitudinal side 114 of the retaining element 11
R_{d} opening radius of the distal longitudinal side 115 of the retaining element 11
SW1 first pivoting angle
SW2 second pivoting angle.

1-15 (canceled)

16. A device for connecting a leg of a person to a movement mechanism, the device comprising:
a retaining element including:
at least one connecting element for directly connecting said retaining element to the movement mechanism, said at least one connecting element configured to permit a rotation of said retaining element relative to a longitudinal axis of said at least one connecting element; and
a fixing device for fixing the leg of the person to said retaining element.

17. The device according to claim 1, wherein said retaining element is at least partially arc-shaped and has an arc opening counter to an extension of said at least one connecting element, and said retaining element has a proximal longitudinal side, a distal longitudinal side and opening radii of said proximal longitudinal side and of said distal longitudinal side being equal or different.

18. The device according to claim 16, wherein said retaining element is made of a relatively stiff material or a relatively stiff plastic material.

19. The device according to claim 16, wherein said retaining element is at least partially surface-treated or surface-coated.

20. The device according to claim 16, wherein said retaining element has an upper side, a proximal longitudinal side, a distal longitudinal side and transverse sides, and said at least one connecting element is disposed centrally on said upper side relative to at least one of said upper side, said proximal longitudinal side, said distal longitudinal side or said transverse sides of said retaining element.

21. The device according to claim 16, wherein said at least one connecting element is a pin mounted rotatably or disposed fixedly on said retaining element.

22. The device according to claim 21, wherein said pin is guided through an opening in said retaining element.

23. The device according to claim 16, wherein said retaining element has an upper side, and at least two holders are disposed on said upper side for said fixing device.

24. The device according to claim 23, wherein:
said upper side of said retaining element has a longitudinal axis, a transverse axis and a normal to said upper side of said retaining element;
said at least two holders are connected directly or indirectly to said retaining element; and
said at least two holders are constructed to be at least one of:
pivotable relative to at least one of said longitudinal axis or said normal to said upper side of said retaining element, or
rotatable relative to at least one of said transverse axis or said normal to said upper side of said holding element.

25. The device according to claim 24, which further comprises fastening devices connecting said at least two holders to said retaining element.

26. The device according to claim 16, wherein said fixing device is at least one of formed of a flexible material or includes at least one closure.

27. The device according to claim 16, wherein said fixing device has transverse sides, and said fixing device is reversibly connectable to said retaining element at least at one of said transverse sides.

28. The device according to claim 16, which further comprises a first padding element configured to be disposed on an underside of said retaining element, and at least one connecting device configured to reversibly connect said first padding element directly or indirectly to said retaining element.

29. The device according to claim 28, wherein said first padding element corresponds in shape to said retaining element or to said underside of said retaining element.

30. The device according to claim 28, wherein said first padding element has at least one closure.

31. The device according to claim 30, wherein said first padding element has a connecting device including said at least one closure.

32. The device according to claim 30, wherein at least one closure is at least one of a press stud or a magnetic closure.

33. The device according to claim 28, which further comprises a second padding element disposed on said fixing device.

34. The device according to claim 33, wherein said second padding element is at least partially arc-shaped.

35. The device according to claim 33, wherein said second padding element is at least one of displaceable relative to a longitudinal side of said fixing device or reversibly connectable to said fixing device.

36. The device according to claim 35, which further comprises a holder for displacing or reversibly connecting said second padding element to said fixing device, said holder being constructed as at least one of a guide slot or tunnel or as a hook-and-loop fastener.

37. The device according to claim 33, wherein said first padding element or said second padding element is made entirely or partially of an elastic material.

38. The device according to claim 37, wherein said second padding element includes a support element made of a rigid material, or a plastic, or a plastic from which said retaining element is made.
